(19) United States
(12) Patent Application Publication
(10) Pub. No.: US 2025/0003440 A1
(43) Pub. Date: Jan. 2, 2025

(54) SCREW

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); CHEN-LONG SU, KAOHSIUNG CITY (TW)

(21) Appl. No.: 18/343,997

(22) Filed: Jun. 29, 2023

(51) Int. Cl. F16B 25/00; F16B 35/04

(52) U.S. Cl. CPC F16B 25/0063; F16B 35/041; F16B 25/106

(57) ABSTRACT

A screw includes a shank defining an exposed surface portion, a head and a drill section disposed at two opposite ends of the shank, and thread convolutions spirally disposed in a spiral direction and axially spaced apart. Each thread convolution has an upper thread flank and a lower thread flank. A groove is recessedly formed in the surface portion and extends annularly in the spiral direction, and a plurality of slots are recessedly formed in the surface portion and extends axially from at least one lower thread flank to meet the groove. Accordingly, the groove and the slots are adapted to enlarge spaces for moving and accommodating chips, thereby attaining a quick removal of chips, reducing screwing resistance, and accelerating a screwing operation. The accumulation of remaining chips within the groove and the slots facilitates a tight engagement between the screw and a workpiece and attains an anti-loosening effect.

### BACKGROUND OF THE INVENTION

### 1. Field of the Invention

This invention relates to a screw and relates particularly to a screw capable of providing enough spaces for moving and accommodating chips, reducing screwing resistance, and attaining a tight engagement.

### 2. Description of the Related Art

Referring to FIGS. 1 and 2, a conventional screw 1 comprises a shank 11 having a first end and a second end opposite to the first end, a head 12 disposed at the first end of the shank 11, a drill section 13 disposed at the second end of the shank 11, and a threaded section 14 spirally disposed on the shank 11. The thread section 14 has a plurality of thread convolutions 14A disposed between the first end and the second end of the shank 11 in a spiral direction. Each thread convolution 14A has an upper thread flank 141 facing the head 12 and a lower thread flank 142 facing the drill section 13. The upper thread flank 141 and the lower thread flank 142 of each thread convolution 14A extend outwards from the shank 11 respectively and connect together. During a screwing operation, the drill section 13 is positioned at a surface of a workpiece 2. The head 12 then receives a rotational force in order to carry out a cutting operation of the thread convolutions 14A into the workpiece 2 and synchronously to screw the shank 11 into the workpiece 2 gradually whereby the screwing operation is completed.

However, the screw 1 is provided without enough spaces for accommodating and moving chips generated during the screwing operation. The chips are discharged only through the spaces formed between the thread convolutions 14A and the shank 11, but the spaces are narrow. Therefore, the chips are discharged slowly, and that will increase the screwing resistance. The screw 1 cannot screw into the workpiece 2 quickly. If the screw 1 keeps pressing the chips, the workpiece 2 may crack. Further, the screw 1 cannot hold the remaining chips, and that will result in a poor engagement between the screw 1 and the workpiece 2. The screw 1 may be loose and fall from the workpiece 2, and that requires to be improved.

### SUMMARY OF THE INVENTION

The object of this invention is to provide a screw capable of providing enough spaces for chips exclusion and accommodation, reducing screwing resistance, increasing screwing speed, and achieving a tight engagement between the screw and a workpiece.

The screw of this invention comprises a shank defining a surface portion exposed outside and having opposite first and second ends, a head formed at the first end, a drill section formed at the second end, a threaded section having a plurality of thread convolutions formed between the first end and the second end in a spiral direction, a groove recessedly formed in the surface portion and extending annularly in the spiral direction, and a slot region recessedly formed in the surface portion and arranged along the spiral direction. Each thread convolution has an upper thread flank and a lower thread flank facing opposite directions. The groove is situated between at least one upper thread flank and the slot region. The slot region has a plurality of slots extending axially from at least one lower thread flank and meeting the groove, thereby communicating with the groove. During a screwing operation, the groove and the slots enlarge spaces for discharging and holding chips. The chips are excluded through the groove along the thread convolutions, and simultaneously enter into the slots through the groove. Thus, the chips are removed quickly without accumulating unduly to thereby reduce the screwing resistance, accelerate the screwing operation, and prevent a workpiece from cracking caused by pressing the accumulated chips. Further, the groove and the slots are adapted to accommodate the remainder of chips properly after the screw is embedded in the workpiece to thereby attain a tight engagement between the screw and the workpiece and attain an anti-loosening effect.

Preferably, the groove extends between part of the thread convolutions.

Preferably, the slot region is arranged between part of the thread convolutions.

Preferably, a maximum depth of each slot is different from a maximum depth of the groove.

Preferably, the shank defines a central axis. The extension of the slots is parallel to the central axis of the shank.

Preferably, the shank defines a central axis. The extension of the slots is inclined to the central axis of the shank.

Preferably, the groove is curved in shape.

Preferably, each slot is curved in shape.

### BRIEF DESCRIPTION OF THE DRAWINGS

FIG. 1 is a schematic view showing a conventional screw;

FIG. 2 is a schematic view showing a screwing operation of the conventional screw;

FIG. 3 is a perspective view showing a first preferred embodiment of this invention;

FIG. 4 is a cross-sectional view showing the maximum depth of the groove and the maximum depth of the slot;

FIG. 5 is a schematic view showing a screwing operation of the first preferred embodiment of this invention;

FIG. 6 is a schematic view showing a second preferred embodiment of this invention; and

FIG. 6A is an enlarged view of the encircled portion 6A indicated in FIG. 6.

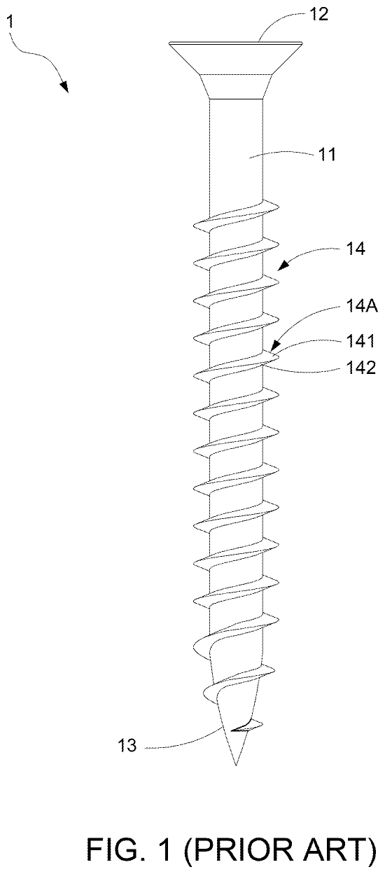

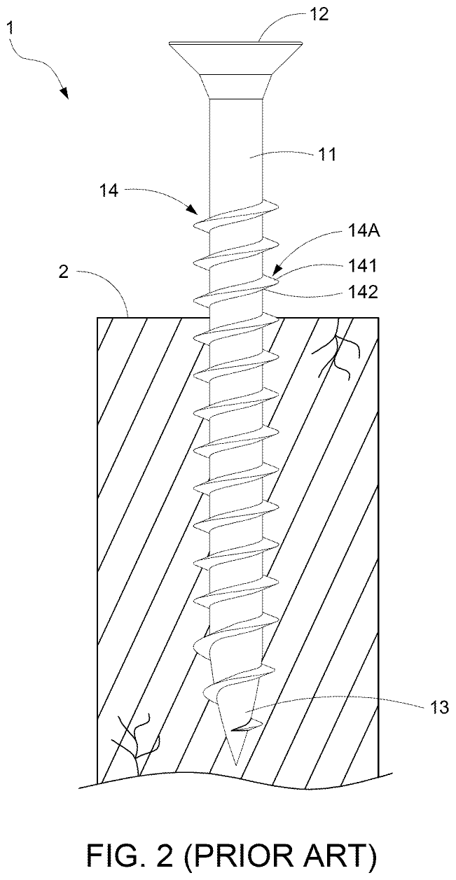

### DETAILED DESCRIPTION OF THE PREFERRED EMBODIMENTS

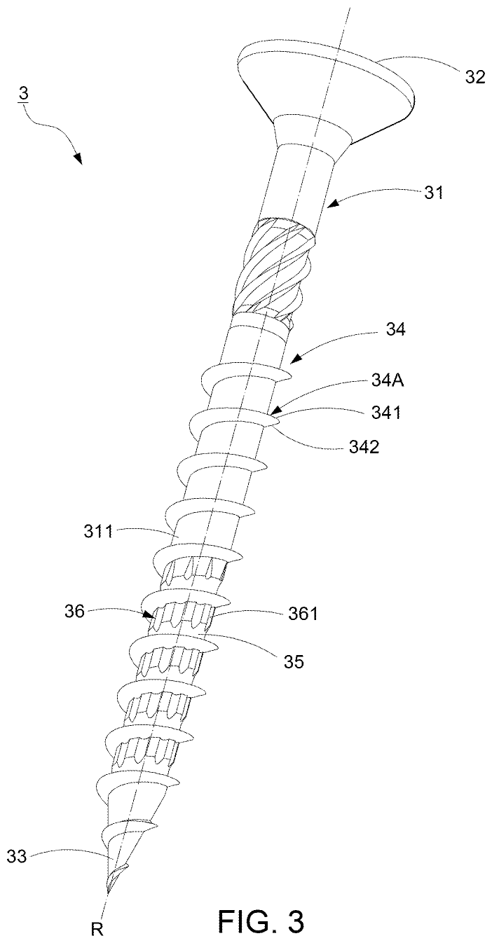

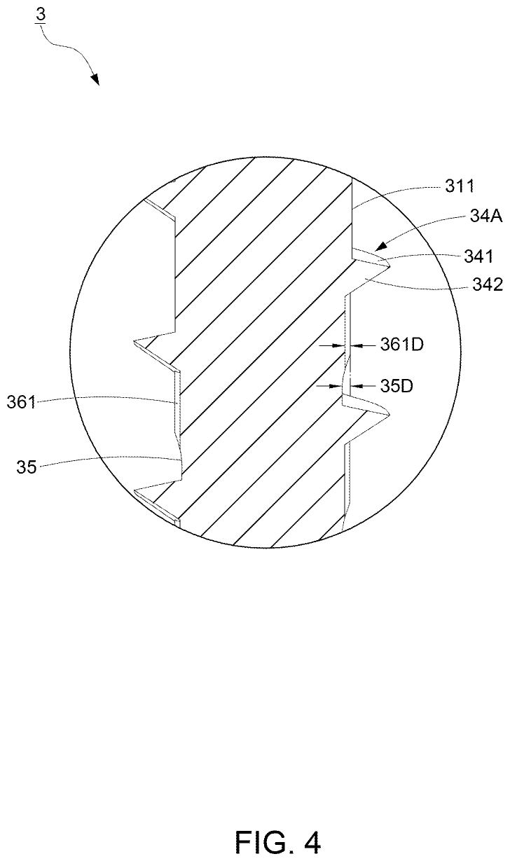

Referring to FIGS. 3 and 4, a first preferred embodiment of a screw 3 of this invention is disclosed. The screw 3 includes a shank 31 having a first end and a second end opposite to the first end, a head 32 disposed at the first end of the shank 31, a drill section 33 disposed at the second end of the shank 31, a threaded section 34 spirally disposed on the shank 31, a groove 35 and a slot region 36 recessedly formed in the shank 31. The threaded section 34 has a plurality of thread convolutions 34A disposed between the first end and the second end of the shank 31 in a spiral direction. The shank 31 defines a central axis R and has a surface portion 311 exposed to an outside when adjacent thread convolutions 34A separate axially from each other in an axial direction. In this preferred embodiment, the groove 35 extends between five and six thread convolutions 34A. The slots region 36 is situated between four and five thread convolutions 34A.

Each thread convolution 34A has an upper thread flank 341 facing the head 32 and a lower thread flank 342 facing the drill section 33. The upper thread flank 341 and the lower thread flank 342 of each thread convolution 34A slantingly extend outwards from the shank 31 respectively and connect together. The groove 35 is recessedly formed in the surface portion 311 and extends annularly in the spiral direction of the threaded section 34 to be situated between at least one upper thread flank 341 and the slot region 36. The slot region 36 is recessedly formed in the surface portion 311 and arranged along the spiral direction. The slot region 36 has a plurality of slots 361 extending in the axial direction and situated between the groove 35 and at least one lower thread flank 342. The slots 361 extend from the at least one lower thread flank 342 and meet the groove 35 to thereby communicate with the groove 35. In this preferred embodiment, each slot 361 extends in a direction parallel to the central axis R of the shank 31. The groove 35 and the slots 361 are curved in shape. A maximum depth 361D of each slot 361 is different from a maximum depth 35D of the groove 35 as shown in FIG. 4.

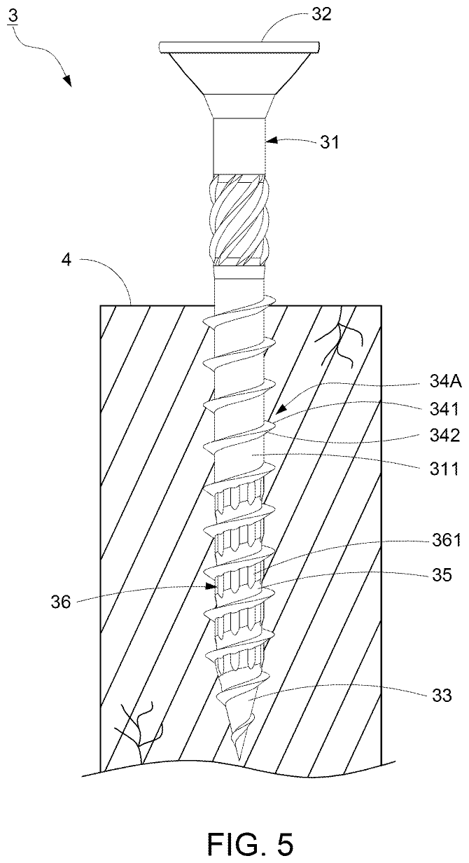

Referring to FIGS. 3, 4 and 5, a screwing operation of the screw 3 begins with positioning the drill section 33 against a surface of a workpiece 4. A rotational force is then applied to the head 32 in order to carry out a cutting operation of the drill section 33 and the thread convolutions 34A. Chips generated during the cutting operation are discharged outwards along the thread convolutions 34A thereafter. Because the shank 31 is provided with the slots 361 and the groove 35 formed recessedly in the surface portion 311, the slots 361 and the groove 35 assist in enlarging spaces for moving and accommodating the chips. Thus, the chips are removed not only along the groove 35, but also through the slots 361 to the outside. In other words, the chips move along the groove 35 and enter into the slots 361 through the groove 35 because the slots 361 communicate with the groove 35 to thereby attain a quick and smooth removal of the chips, reduce the screwing resistance greatly, and prevent the screw 3 from being hindered by the chips during the screwing operation. Accordingly, the screw 3 can screw into the workpiece 4 speedily and the screwing speed is increased. Meanwhile, the chips will not accumulate unduly. Without the unduly accumulated chips, the screw 3 can thread into the workpiece 4 smoothly, and that prevents the workpiece 4 from cracking. After the screw 3 is embedded in the workpiece 4, some remaining chips are held within the groove 35 and the slots 361 to thereby attain a tight engagement between the screw 3 and the workpiece 4, prevent the screw 3 from being loose, and attain an anti-loosening effect.

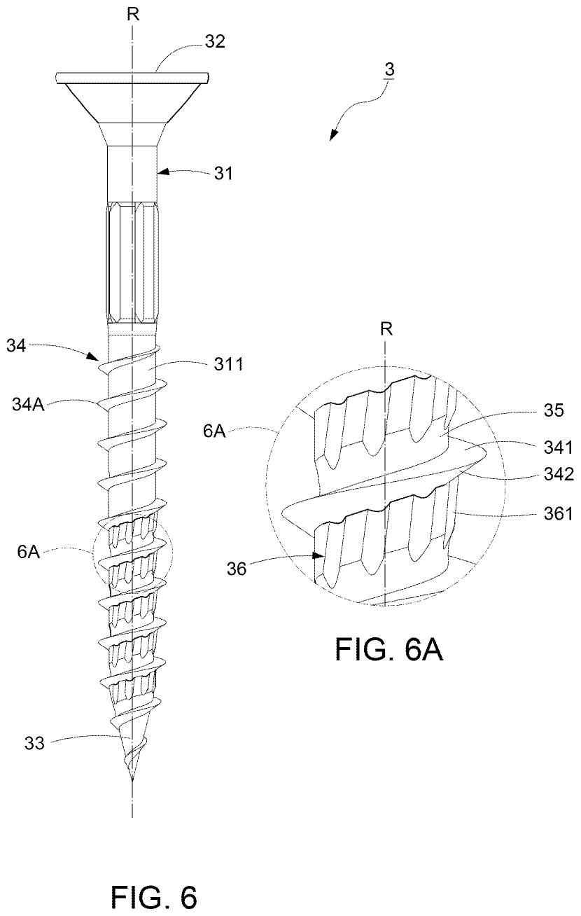

Referring to FIGS. 6 and 6A show a second preferred embodiment of the screw 3 of this invention. The correlated elements and the concatenation of elements, the operation and objectives of the second preferred embodiment are the same as those of the first preferred embodiment. This embodiment is characterized in that each slot 361 extends in a direction inclined to the central axis R of the shank 31. An inclined direction of the slots 361 can be varied according to needs. Thus, the screwing direction of the screw 3 allows the chips to enter into the inclined slots 361 easily through the groove 35, thereby discharging the chips outwards quickly and smoothly. Further, the slots 361 and the groove 35 can also accommodate the remainder of chips properly whereby the screw 3 engages with the workpiece 4 tightly.

To sum up, the screw of this invention takes an advantage that the groove and the slot region are recessedly formed in the surface portion of the shank. The groove extends spirally in the spiral direction of the threaded section and situated between at least one upper thread flank and the slot region. The slots of the slot region extend axially from at least one lower thread flank to further meet and communicate with the groove. Hence, the groove and the slots allow the chips to be moved outwards speedily to thereby reduce the screwing resistance, increase the screwing speed, and accelerate the screwing operation. Further, the groove and the slots are also adapted to keep sufficient chips duly to thereby attain the stable engagement between the screw and the workpiece and attain the anti-loosening effect.

While the embodiments of this invention are shown and described, it is understood that further variations and modifications may be made without departing from the scope of this invention.

What is claimed is:

1. A screw comprising a shank having opposite first and second ends, a head disposed at said first end, a drill section disposed at said second end, and a threaded section including a plurality of thread convolutions disposed between said first end and said second end in a spiral direction, each of said plurality of thread convolutions having an upper thread flank facing said head and a lower thread flank facing said drill section;
wherein said shank defines a surface portion exposed to an outside when adjacent thread convolutions are axially spaced apart in an axial direction, a groove and a slot region including a plurality of slots being respectively and recessedly formed in said surface portion, said groove extending annularly in said spiral direction of said threaded section and situated between at least one upper thread flank of said plurality of thread convolutions and said slot region, said slot region being arranged along said spiral direction, with said plurality of slots of said slot region extending in said axial direction and situated between said groove and at least one lower thread flank of said plurality of thread convolutions, said plurality of slots extending from said at least one lower thread flank and meeting said groove, and said plurality of slots thereby communicating with said groove.

2. The screw according to claim 1, wherein said groove extends between part of said thread convolutions.

3. The screw according to claim 1, wherein said slot region is arranged between part of said thread convolutions.

4. The screw according to claim 1, wherein a maximum depth of each of said plurality of slots is different from a maximum depth of said groove.

5. The screw according to claim 1, wherein said shank defines a central axis, the extension of said plurality of slots being parallel to said central axis of said shank.

6. The screw according to claim 1, wherein said shank defines a central axis, the extension of said plurality of slots being inclined to said central axis of said shank.

7. The screw according to claim 1, wherein said groove is curved in shape.

8. The screw according to claim 1, wherein each of said plurality of slots is curved in shape.
